(19) United States
(12) Patent Application Publication
(10) Pub. No.: US 2011/0247898 A1
(43) Pub. Date: Oct. 13, 2011

(54) PORTABLE STEPPING SYSTEM

(76) Inventor: Norma Wigutoff, Seattle, WA (US)

(21) Appl. No.: 12/757,751

(22) Filed: Apr. 9, 2010

(51) Int. Cl. A47C 12/00; B60R 3/00; E04G 1/00; E06C 1/00

(52) U.S. Cl. 182/223

(57) ABSTRACT

A stepping platform includes an upper step platform and a lower step platform. The stepping platform may be manually moved from a stored position to a deployed, and vice-versa. The upper step platform includes a tread surface and side walls that cooperate to define a cavity into which the lower step platform fits when the stepping platform is in the stored position. The lower step platform also includes a tread surface and side walls. In one embodiment, a height of the lower step platform is about half of an overall height of the upper step platform. Further, both platforms may include tread surface areas sized to support both feet of a standing adult.

### FIELD OF THE INVENTION

The present invention generally relates to a stepping system, and more specifically to a manually deployable and portable stepping system.

### SUMMARY OF THE INVENTION

An embodiment of the present invention includes a stepping platform that is more stable and on which maneuvering is easier than conventional steps or stools. The stepping platform is manually collapsible and transportable, including an upper step platform and a lower step platform. The upper step platform defines a cavity sized to receive the lower step platform when the stepping platform is closed in a clamshell-fashion. Thus when folded or in a stored position, the lower step platform is completely tucked inside the upper step platform, and in one embodiment may be manually rotated out about a pivot joint or pin. In the presently preferred embodiment, each tread surface of each platform shall be large enough for a grown person, possibly with limited mobility, to comfortably turn around on or at least to place both feet on. The overall height of the lower step platform when in the deployed or unfolded position is about half that of the upper step platform.

In one aspect of the present invention, a stepping system includes a first step platform having a first step tread surface coupled to a riser and a plurality of side walls to define a first step platform cavity; a second step platform having a second step tread surface and a periphery sized to be receivable into the first step platform cavity, wherein a height of the second step platform is about half a height of the first step platform; and a connection mechanism coupled to the first step platform and configured to engage the second step platform, the connection mechanism arranged such that the second step platform is manually rotatable relative to the first step platform.

In another aspect of the present invention, a method of ingress or egress from a vehicle, the method including the steps of (1) arranging an upper step platform of a stepping system proximate a vehicle door; (2) manually moving a lower step platform relative to the upper step platform, each step platform sized to support both feet of a standing adult; (3) stepping onto one of either the upper or lower step platforms; and (4) stepping next onto the other one of the upper or lower step platforms, wherein a height of the lower step platform is about half a height of the upper step platform.

### BRIEF DESCRIPTION OF THE DRAWINGS

Preferred and alternative embodiments of the present invention are described in detail below with reference to the following drawings.

FIG. 1 is a perspective view of a stepping system in a deployed configuration according to an embodiment of the present invention;

FIG. 2 is a perspective view of the stepping system of FIG. 1 being moved into a stored configuration according to an embodiment of the present invention;

FIG. 3 is a perspective view of the stepping system of FIG. 1 in the stored configuration according to an embodiment of the present invention;

FIG. 4 is a perspective view of a first step platform with a track mechanism according to an embodiment of the present invention.

### DETAILED DESCRIPTION OF THE PREFERRED EMBODIMENTS

The present invention generally relates to, but is not limited to, a manually collapsible stepping platform that is more stable and on which maneuvering is easier than conventional steps or stools.

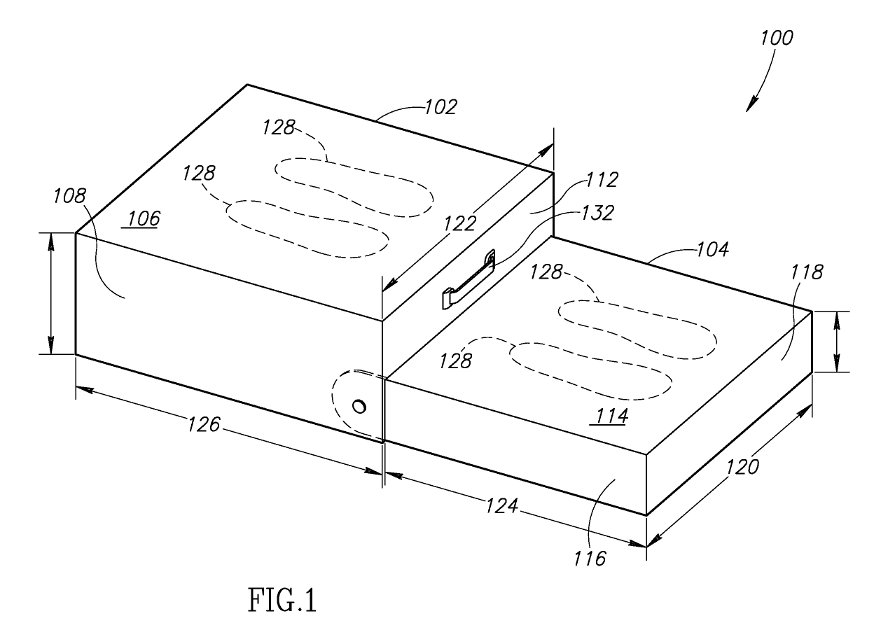

FIG. 1 shows a stepping platform 100 having an upper step platform 102 and a lower step platform 104. The stepping platform 100 is shown in a deployed position. The upper step platform 102 includes an upper step tread surface 106 and a plurality of upper step side walls 108 that cooperate to define a cavity 110 (FIG. 3). The front side wall 108 may take the form of a riser 112. The lower step platform 104 includes a lower step tread surface 114 and a plurality of lower step side walls 116. The front side wall 116 may take the form of a lower step riser 118. The lower step side walls 116 define a periphery sized to be received into the cavity 110 of the upper step platform 102 when the stepping platform 100 is in a folded position. More specifically, a width 120 of the lower step platform 104 is less than a width 122 of the upper step platform 102. And, a length 124 of the lower step platform 104 is less than a length 126 of the upper step platform 102. In one embodiment, a height 127 of the lower step platform 104 is about half of an overall height 129 of the upper step platform 102. Additionally or alternatively, the stepping platform 100 may have multiple levels and be configured for people who are unable or have difficulty climbing more than two to three inches per step. As such, the change of elevation from one step to the next may be no greater than three inches and preferably about two and a half inches. Further, the area of each platform is large enough to allow the person to stand thereon and make a complete, 360 degree, turn.

The tread surfaces 106, 114 may have a surface area that is sufficient to receive at least two footfalls 128, that is sufficient to allow a person standing thereon to maneuver both feet without being too close to the sidewalls 108, 116, or both. The tread surfaces 106, 114 may include a nonslip coating (not shown), have a roughened surface texture, or both. In addition, the stepping platform 100 may include a hard rubber or other rugged, nonslip material along a bottom edge to prevent or minimize movement of the stepping platform 100 relative to a ground surface (not shown). The first and second step platforms 102, 104 may take a variety of shapes, such as square, rectangular, curved or otherwise contoured (e.g., rounded corners).

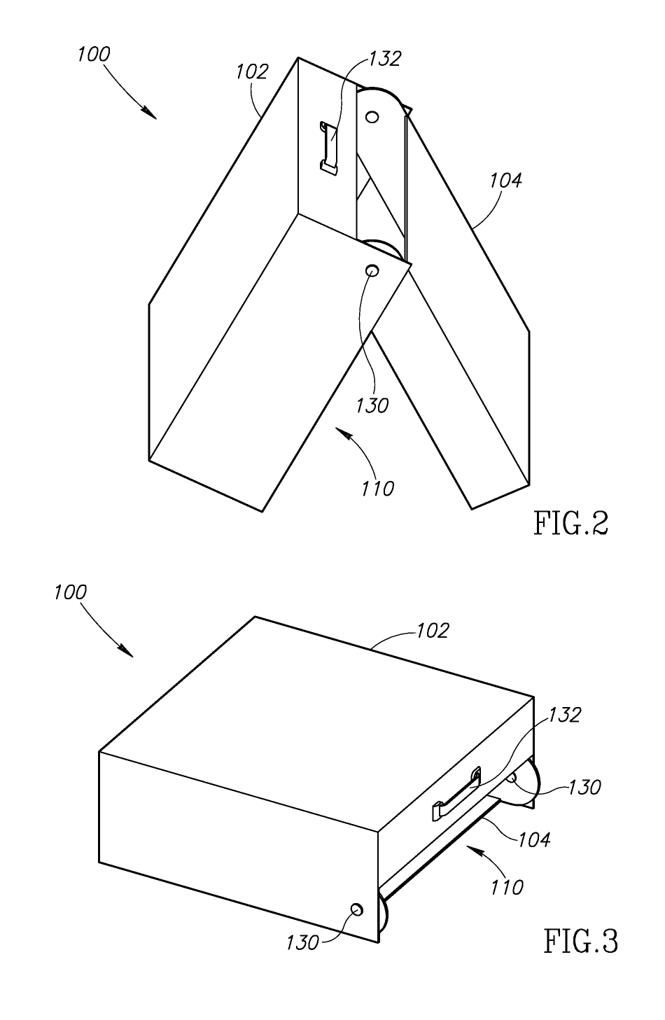

FIG. 2 shows the stepping platform 100 in which the lower step platform 104 is pivotable into the cavity 110 of the upper step platform 102. A pivot mechanism 130 may take the form of a continuous pin or two separate pins having the same pivot axis. Further, a lockable hinge mechanism (not shown), such as a piano-type hinge, may be coupled to the upper and lower step platforms 102, 104. A handle 132 may be coupled to the stepping platform 100 to allow the stepping system 100 to be transported when in a folded or stored position. In the illustrated embodiment, the handle 132 is coupled to the riser 112 of the upper step platform 102. FIG. 3 shows the stepping platform 100 in the fully folded or stored configuration. In the illustrated embodiment, the lower step platform 104 may be folded or otherwise completely tucked inside the upper step platform 102.

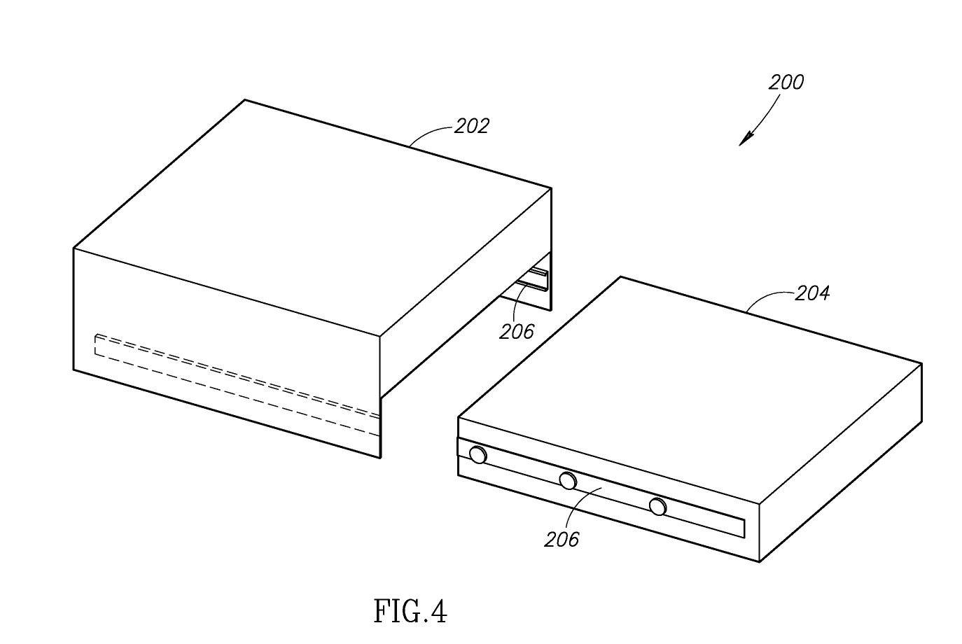

FIG. 4 shows a stepping system 200 having an upper step platform 202 slidably coupled to a lower step platform 204. In one embodiment, a track or guide 206, similar to a draw guide, may be used to telescopically move the lower step platform 204 relative to the upper step platform 202.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A stepping system comprising:
a first step platform having a first step tread surface coupled to a riser and a plurality of side walls to define a first step platform cavity;
a second step platform having a second step tread surface and a periphery sized to be receivable into the first step platform cavity, wherein a height of the second step platform is about half a height of the first step platform; and
a pivot mechanism coupled to the first step platform and configured to engage the second step platform, the connection mechanism arranged such that the second step platform is manually rotatable relative to the first step platform.

2. The stepping system of claim 1, wherein the pivot mechanism includes a pin having a rotational axis about which the second step platform rotates.

3. The stepping system of claim 1, wherein a surface area of the first step tread surface is sized to support both feet of a standing adult.

4. The stepping system of claim 1, wherein a surface area of the second step tread surface is sized to support both feet of a standing adult.

5. The stepping system of claim 1, further comprising a handle coupled to the riser of the first step platform.

6. The stepping system of claim 1, wherein the second step platform extends from the riser when the stepping system is in a deployed configuration.

7. The stepping system of claim 1, wherein the second step platform is completely received within the first step platform cavity when the stepping system is in a stored configuration.

8. The stepping system of claim 1, wherein the connection mechanism includes a track on which the second step platform translates.

9. A method of ingress or egress from a vehicle, the method comprising:
arranging an upper step platform of a stepping system proximate a vehicle door;
manually moving a lower step platform relative to the upper step platform, each step platform sized to support both feet of a standing adult;
stepping onto one of either the upper or lower step platforms; and
stepping next onto the other one of the upper or lower step platforms, wherein a height of the lower step platform is about half a height of the upper step platform.

10. The method of claim 9, wherein arranging the stepping system proximate the vehicle door includes placing the stepping system within a desired stepping distance from the vehicle door.

11. The method of claim 9, wherein manually moving the lower step platform relative to the upper step platform includes rotating the lower step platform relative to the upper step platform.

12. The method of claim 11, wherein rotating the lower step platform relative to the upper step platform includes pivoting the lower step platform about a pin coupled to both platforms.

13. The method of claim 9, wherein manually moving the lower step platform relative to the upper step platform includes telescopically translating the lower step platform relative to the upper step platform.

14. The method of claim 13, wherein telescopically translating the lower step platform relative to the upper step platform includes moving the lower step platform on a track coupled to the upper step platform.
